(19) United States
(12) Patent Application Publication
(10) Pub. No.: US 2022/0306099 A1
(43) Pub. Date: Sep. 29, 2022

(54) METHOD AND TRACK GUIDANCE SYSTEM FOR CONTROLLING AN AUTONOMOUS MOTOR VEHICLE IN AN URBAN AREA

(71) Applicant: AUDI AG, Ingolstadt (DE)

(72) Inventor: Bodo KLEICKMANN, Ingolstadt (DE)

(73) Assignee: AUDI AG, Ingolstadt (DE)

(21) Appl. No.: 17/608,848

(22) PCT Filed: May 15, 2020
(86) PCT No.: PCT/EP2020/063566

§ 371 Date: Nov. 4, 2021

(30) Foreign Application Priority Data
Jun. 13, 2019 (DE) 10 2019 208 647.0

(51) Int. Cl. B60W 30/14; B60W 30/095; B60W 60/00; B60W 40/04; B60W 40/105; G06V 20/56

(52) U.S. Cl. CPC B60W 30/143; B60W 30/0956; B60W 60/0015; B60W 40/04; B60W 40/105; G06V 20/588; B60W 2420/42; B60W 2420/50; B60W 2552/53; B60W 2554/4029; B60W 2554/4041; B60W 2554/4045; B60W 2554/80

(57) ABSTRACT

A determination is made regarding whether an autonomous motor vehicle is located on a specified lane marking. If so, the autonomous motor vehicle is controlled on the specified lane marking and the vehicle speed is limited to a specified speed value. If the autonomous motor vehicle is not located on the specified lane marking, the vehicle speed is limited to a specified safe value.

### CROSS REFERENCE TO RELATED APPLICATIONS

This application is a U.S. national stage of International Application No. PCT/EP2020/063566, filed on May 15, 2020. The International Application claims the priority benefit of German Application No. 10 2019 208 647.0 filed on Jun. 13, 2019. Both the International Application and the German Application are incorporated by reference herein in their entirety.

### BACKGROUND

Described below are a method and a track guidance system for controlling an autonomous motor vehicle in an urban area.

In an urban area, high demands are placed on autonomously driving motor vehicles with respect to an interpretation of a traffic situation and a decision derived therefrom in order to ensure traffic safety, since the autonomous motor vehicle has to interact in the urban area with further road users, for example, pedestrians and bicyclists.

A use of autonomous motor vehicles in the urban area is dependent in particular on legal boundary conditions and societal acceptance, for example of traffic safety. In particular, a question of guilt in critical situations and/or a moral action in such a situation is unclear for autonomous motor vehicles.

A facility for autonomous driving of a vehicle is known from DE 10 2017 202 676 A1. The facility comprises a lane which is structurally separated by a lane boundary from a further lane, wherein a vehicle registers in a registration area to use the lane and deregisters in a deregistration area from the use of the lane.

However, it is disadvantageous in the prior art that a structurally separated lane has to be provided, which can only be used by the autonomous motor vehicle. Outside this lane, thus on the roads of the urban area in which other road users are also underway, a behavior of the autonomous motor vehicle is unclear.

### SUMMARY

The method described herein increases a level of traffic safety for the use of an autonomous motor vehicle in an urban area.

The method is based on the finding that for a vehicle speed below a predefined safety value, an autonomous motor vehicle can detect a critical driving situation and, for example, without steering interventions and exclusively by braking, can be put into a safe state, whereby accidents can be avoided. To nonetheless be able to move at a higher vehicle speed, predefined roadway markings are provided, on which a release of the vehicle speed can take place.

A method for controlling an autonomous motor vehicle in an urban area is described herein. The method begins by determining whether the autonomous motor vehicle is located on a predefined roadway marking. If not, a vehicle speed is limited to a predefined safety value. If the vehicle is located on a predefined roadway marking, the autonomous motor vehicle is controlled based on the predefined roadway marking and the vehicle speed is limited to a predefined speed value.

In other words, in an urban area, for example a city, predefined roadway markings are provided on which the autonomous motor vehicle can drive at a vehicle speed up to a predefined speed value, wherein the predefined speed value can in particular conform to a permitted vehicle speed of the urban area. For example, in a city the speed can be limited to 50 km/h, so that the autonomous motor vehicle can drive up to 50 km/h on the predefined roadway marking. In other words, the predefined roadway marking specifies a movement of the autonomous motor vehicle in the vehicle transverse direction, while the movement in the longitudinal direction along the predefined roadway marking is planned by the autonomous motor vehicle, or in conjunction with a traffic infrastructure, respectively.

However, if it is determined that the autonomous motor vehicle is not located on the predefined roadway marking, the vehicle speed can be limited to another predefined safety value, which in particular can be less than the permitted vehicle speed of the urban area. The other predefined safety value can be in a range in which emergency braking of the motor vehicle can result in an immediate vehicle standstill, that is to say in particular a braking distance of less than 1 m. For example, the predefined safety value can be in a range of 5 to 30 km/h, such as a range of 12 to 15 km/h.

The predefined roadway marking may stand out from a surrounding road covering, in particular due to a defined signal color. The predefined roadway marking can also be indicated by an existing traffic infrastructure, for example tram rails, over which the autonomous motor vehicle can drive. Similarly as in the case of a tram rail, the predefined roadway marking also has the task of warning of autonomous motor vehicles, that is to say passersby are aware that they enter an area in which an autonomously driving motor vehicle is to be expected. If an accident occurs here, for example, because a road user is suddenly on the predefined roadway marking, a definition of the legal question of fault can be facilitated, whereby the probability is increased that autonomously driving motor vehicles are implemented in an urban area.

The determination of whether the autonomous motor vehicle is located on the predefined roadway marking can be carried out by a sensor unit which has, for example, optical sensors, in particular a camera or a lidar sensor, and/or position sensors, which receive external positioning signals, for example, GPS or reference signals of an infrastructure of the urban area. The predefined speed value may also be detected by the sensor unit. For example, a vehicle camera can also read traffic signs in addition to the predefined roadway marking, which can be, for example, a solid line in the center of the lane, and can thus determine the permissible speed value at a position.

It may be determined that the autonomous motor vehicle is located on the predefined roadway marking when a vehicle center of gravity or a vehicle center point is within a tolerance area on the predefined roadway marking. For example, in the case of a solid line as the predefined roadway marking, a tolerance range ±30 cm can be defined starting from the vehicle center, for which it is determined that the autonomous motor vehicle is located on the predefined roadway marking.

One advantage is that a vehicle speed of the autonomous motor vehicle is comprehensible to other road users and a comprehensible behavior of the autonomous motor vehicle is enabled by the predefined roadway marking. In an area outside the predefined roadway marking, in which a travel direction and a behavior of the autonomous motor vehicle cannot be predicted by other road users, the speed can be limited to the predefined safety value, whereby the safety is ensured in this area by a short braking distance of, for example, less than 1 m. Critical traffic situations can be reduced in this way and a level of traffic safety can be increased as a whole.

In the embodiments, additional advantages result.

One embodiment provides that the control using the roadway marking includes ascertaining whether an object is located within a safety area in front of the autonomous motor vehicle, wherein the safety area extends along the predefined roadway marking. In this case, a reduction of the vehicle speed to an object speed, wherein the autonomous motor vehicle remains on the predefined roadway marking during the reduction of the vehicle speed if the vehicle speed is above the predefined safety value.

In other words, it can be ascertained whether an object is located along the predefined roadway marking inside a safety area, wherein the safety area can have a width, for example, which corresponds to the width of the autonomous motor vehicle or the lane, and a length along the predefined roadway marking, which can be adapted in particular to the vehicle speed and which can correspond to a braking distance at a current vehicle speed. For example, a length of the safety area at a vehicle speed of 50 km/h can be 25 m. In particular, the safety area is not static, but rather can travel along with the autonomous motor vehicle depending on the vehicle speed.

If an object is detected in this safety area, the vehicle speed can adapt itself to an object speed without leaving the predefined roadway marking at the same time. For example, the object can be a vehicle traveling ahead and the autonomous motor vehicle can adapt itself to the speed of the vehicle traveling ahead.

Alternatively or additionally, the object can also be a road user, for example, a pedestrian, who enters the safety area in front of the autonomous motor vehicle. The reduction of the vehicle speed to the object speed can be a braking process down to a standstill of the autonomous motor vehicle here. In particular, the autonomous motor vehicle can also brake to a standstill in the event of an oncoming object. In addition, however, it can be provided in the case of the reduction of the vehicle speed that the predefined roadway marking is not left as long as the vehicle speed is above the predefined safety value. The predefined roadway marking, similarly to a tram rail, thus has the task of warning about autonomous motor vehicles, that is to say passersby are aware that an area is entered in which an autonomous motor vehicle is to be expected.

If a collision is not avoidable due to a sudden entry of an object, for example, another vehicle, into the safety area, since the autonomous motor vehicle still has to orient itself in a transverse direction along the predefined roadway marking and only brakes in the longitudinal direction, a conflict of goals, for example, a selection between two collisions can be avoided and the behavior of the autonomous motor vehicle is always comprehensible to further road users.

A behavior of the autonomous motor vehicle in critical driving situations is thus apparent at all times, from which the advantage results that a level of traffic safety can be increased for other road users and legal boundary conditions can be provided for a use of autonomous motor vehicles in the urban area. Furthermore, decision situations can be avoided, since the autonomous motor vehicle only acts according to the rules defined by the method. A decision situation can be, for example, whether the autonomous motor vehicle protects its occupants or other road users, or a selection between various collision participants in the event of an unavoidable collision.

A further embodiment provides that the control using the roadway marking includes ascertainment of whether a movement of the object from an observation area in the direction of the safety area corresponds to a predefined condition. In this case, the vehicle speed is reduced, wherein the autonomous motor vehicle remains on the predefined roadway marking during the reduction of the vehicle speed.

In other words, an observation area is provided around the safety area to check whether an object is moving into the safety area. For example, an object can be detected inside the observation area and a movement of the object can be extrapolated over time, whereby a potential entry into the safety area can be predicted. For this purpose, for example, a speed vector of the object in the direction of the safety area can be determined and it can then be calculated together with a distance of the object to the safety area whether the object is entering the safety area. If this is the case, the predefined condition can be met and the vehicle speed can be reduced without the autonomous motor vehicle deviating from the predefined roadway marking. It is therefore possible to prevent an evasion maneuver from being able to influence other road users.

The object can be, for example, a bicyclist, who is located inside the observation area and rides in the direction of the safety area. The predefined condition can be met in this example if it is determined that the bicyclist will move into the safety area in front of the autonomous motor vehicle if they maintain the direction and the speed. The autonomous motor vehicle can thereupon reduce the vehicle speed and thus decelerate the vehicle speed, for example, to a standstill of the motor vehicle.

The advantage results due to this embodiment that a level of traffic safety can be increased and that objects entering the safety area can also be detected and the autonomous motor vehicle can react thereto. In addition, influencing other road users, for example, due to an abrupt evasion maneuver, can be prevented by remaining on the predefined roadway marking.

There may also be ascertainment of whether the object is located in the safety area or moves in the direction of the safety area is carried out by a vehicle-internal and/or vehicle-external sensor. For example, a vehicle-internal sensor can be a camera or a lidar sensor which can detect an object in the safety area. Alternatively or additionally, sensors of a traffic infrastructure can be provided along the route, which can communicate items of surroundings information, for example, a position of the object, to the autonomous motor vehicle in the scope of a vehicle-to-infrastructure communication. Data of traffic monitoring cameras can be used for this purpose, for example. A further option is a vehicle-to-vehicle communication, wherein, for example, a motor vehicle traveling ahead can warn following motor vehicles. A detection of an object can be improved in this way.

Moreover, a redundancy can be provided by the vehicle-internal and/or vehicle-external sensors in the determination of whether the autonomous motor vehicle is located on the predefined roadway marking. In addition to the physical marking of the predefined roadway marking on the road, which can be detected, for example, via the vehicle-internal sensor, the predefined roadway marking can thus also be stored on a navigation map, wherein the navigation map can either be stored in the motor vehicle or can be provided via a connection to the traffic infrastructure, for example, via 5G. It is thus possible, for example, that the autonomous motor vehicle can be located exactly on the navigation map only with the aid of the vehicle-external sensors, which are used here as infrastructure points or landmarks. For this purpose, for example, the vehicle-internal sensor can detect the infrastructure points in that, for example, a vehicle camera detects a QR code on the infrastructure point and thus identifies it. The precise location of the infrastructure point thus identified can be stored in the navigation map, whereby exact locating of the autonomous motor vehicle on the navigation map is possible. The autonomous motor vehicle can thus follow the predefined roadway marking even without a separate detection.

Furthermore, in the event of a detected deviation between the roadway marking detected by the vehicle-internal sensor and the roadway marking stored in the navigation map, a safety reaction can be triggered, for example, limiting the vehicle speed to the predefined safety value. Alternatively, in addition to the lane in the navigation map and on the road, the motor vehicle can also plan a separate lane, which can be used as a further redundancy.

Therefore, a redundancy can be provided upon the detection of the surroundings and other road users by the vehicle-internal and vehicle-external sensor. Moreover, the possibility can thus be opened up of making the sensor system in the motor vehicle simpler and less expensive, which pays off in particular in the case of a high traffic density in the urban area, since every vehicle does not have to be equipped with an expensive sensor system, but rather this can be transferred to the infrastructure and is therefore available to all vehicles.

A further embodiment provides that the autonomous motor vehicle located on the predefined roadway marking only leaves the predefined roadway marking when the vehicle speed is below the predefined safety value. In other words, the autonomous motor vehicle only deviates from the predefined roadway marking when the vehicle speed falls below the predefined safety value. For example, an object or an obstacle which stands on the predefined roadway marking can thus be driven around. Since the vehicle speed is below the predefined safety value for this purpose, the autonomous motor vehicle can react in a timely manner in the event of unpredicted behavior of other road users and, for example, carry out emergency braking. Leaving the predefined roadway marking, for example, to drive to a parking area, can thus also be carried out. The advantage results due to this embodiment that a level of traffic safety can be increased if the autonomous motor vehicle leaves the predefined roadway marking. A traffic flow can thus also be maintained, whereby congestion can be avoided.

One embodiment provides that the predefined roadway marking divides at an intersection point and wherein a travel route of the autonomous motor vehicle is indicated by an optical signal on and/or in the roadway marking. That is to say the predefined roadway marking can extend in various directions at an intersection and, for example, the autonomous motor vehicle indicates by an optical signal, which can be designed as a light signal, in which direction the autonomous motor vehicle will move and/or an optical signal in the roadway marking indicates the route of the autonomous motor vehicle. The optical signal can be provided by a light band which indicates a route of the autonomous motor vehicle at the intersection point. The travel route which the autonomous motor vehicle takes can be communicated to a signal system on and/or in the roadway marking, for example, via a vehicle-to-infrastructure communication. The advantage results due to this embodiment that an unambiguous movement sequence for the autonomous motor vehicle can be indicated, whereby a level of traffic safety can be increased.

A further embodiment provides that the predefined roadway marking is indicated by a tram rail and/or a marking paint. For example, if a tram rail is used, a traffic infrastructure, for example, a traffic signal system of the tram, can also be used simultaneously. For example, a tram can also only accelerate or decelerate along the tram rails, whereby the behavior of the autonomous motor vehicle is known in a similar manner for other road users. A special marking paint, for example, a luminous paint, can also indicate a travel route of the autonomous motor vehicle. A paint which is admixed with fluorescent paint particles can be used, whereby a forgery can be made more difficult. In particular, a fluorescence in a nonvisible color spectrum can be provided for the marking paint, which can only be detected, for example, by a sensor unit of the autonomous motor vehicle. The autonomous motor vehicle can thus detect and verify the predefined roadway marking.

A further embodiment provides that the predefined roadway marking is furthermore indicated by an electromagnetic signal. The electromagnetic signal can be, for example, a magnetic field of a current-conducting wire which can extend in the predefined roadway marking. The autonomous motor vehicle can have a sensor which can detect this magnetic field, whereby the autonomous motor vehicle can be maneuvered along the wire. A further option is an identification via a radio frequency signal, for example RFID, by which the autonomous motor vehicle can verify the predefined roadway marking and can receive, for example, the predefined speed value. Induction coils can be present in the predefined roadway marking, which, via a corresponding induction coil in the autonomous motor vehicle, can charge a battery of the autonomous motor vehicle in addition to the indication of the roadway. That is to say, the induction coils can be located in the road below the predefined roadway marking, so that the motor vehicle can be charged in a contactless manner when driving on the predefined roadway marking. The induction coils can be supplied with current by the infrastructure points (external sensors) or landmarks, which can be arranged as columns along the road. The infrastructure points (external sensors) along the road can also be used as charging stations for electrically operated motor vehicles. In particular, the external sensors can thus unify multiple functions in one device, for example, the detection of the surroundings, transmission/reception points for the vehicle-to-infrastructure communication (for example 5G), infrastructure points or landmarks for assisting the locating of the motor vehicle, and energy supply points for inductive charging or connected charging. The infrastructure points (external sensors) can be arranged along the section on which a predefined roadway marking is located in such a way that the motor vehicle is always in the field of view of at least one infrastructure point (external sensor).

A further embodiment provides that a speed is used for the predefined safety value, in particular a value in a range of 5 km to 15 km. Safety considerations have shown that within this speed range, in particular at 10 km±a tolerance, for example, of 10%, the autonomous motor vehicle can be put into a safe state by detection of a critical driving situation without steering interventions and exclusively by braking. Accidents can thus be avoided and a level of traffic safety can be increased.

A further aspect relates to a track guidance system for controlling an autonomous motor vehicle in an urban area. The track guidance system has a sensor unit which is designed to determine whether the autonomous motor vehicle is located on a predefined roadway marking. Furthermore, the track guidance system has a control unit which is designed to limit a vehicle speed to a predefined safety value, if the autonomous motor vehicle is not located on the predefined roadway marking, and to control the autonomous motor vehicle and limit the vehicle speed to a predefined speed value if the autonomous motor vehicle is located on the predefined roadway marking. The same advantages and possible variations result here as with the method.

The autonomous motor vehicle may be an automobile, in particular as a passenger vehicle or truck, or a passenger bus.

Also described is a control unit for the autonomous motor vehicle. The control unit has a processor unit, which is configured to carry out an embodiment of the method.

The processor unit can have at least one microprocessor and/or at least one microcontroller for this purpose. Furthermore, the processor unit can have program code which is configured to carry out the embodiments of the method upon execution by the processor unit. The program code can be stored in a data memory of the processor unit.

Also described are refinements of the track guidance system, which have features as have already been described in conjunction with the refinements of the method. For this reason, the corresponding refinements of the track guidance system are not described once again here.

### BRIEF DESCRIPTION OF THE DRAWINGS

These and other aspects and advantages will become more apparent and more readily appreciated from the following description of the exemplary embodiments, taken in conjunction with the accompanying drawings of which:

FIG. 1 is a schematic top view of a track guidance system according to one exemplary embodiment;

FIG. 2 is a schematic top view of a passing process according to one exemplary embodiment of the track guidance system;

FIG. 3 is a schematic top view of a turnoff process according to one exemplary embodiment of the track guidance system;

FIG. 4 is a flowchart according to one exemplary embodiment.

### DETAILED DESCRIPTION

In the exemplary embodiments explained hereinafter, the described components of the embodiments each represent individual features to be considered independently of one another, which each also refine the invention independently of one another. The disclosure also includes combinations of the features of the embodiments other than those shown. Furthermore, the described embodiments can also be supplemented by further features already described.

In the figures, identical reference signs each identify functionally identical elements.

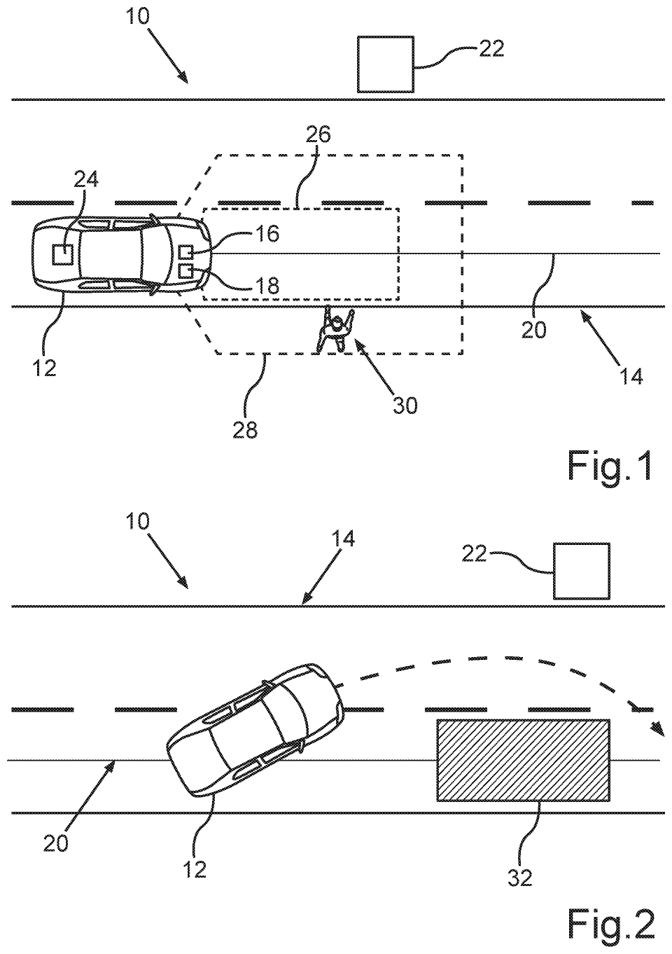

FIG. 1 shows a schematic illustration of a track guidance system 10 for controlling an autonomous motor vehicle 12 in an urban area. The track system 10 can be designed to control the autonomous motor vehicle 12 on a road 14 of the urban area. For this purpose, the autonomous motor vehicle can have a sensor unit 16 and a control unit 18.

The sensor unit 16 can be designed to check whether the autonomous motor vehicle 12 is located on a predefined roadway marking 20. For this purpose, the sensor unit 16 can have, for example, one or more cameras which monitor a road surface. Additionally or alternatively, the sensor unit 16 can also have a vehicle-external sensor 22, which can be designed, for example, as a traffic monitoring column, and which in particular can have a camera to determine a positioning of the autonomous motor vehicle 12 and which can transmit reference points for correcting a positioning of the autonomous motor vehicle to the autonomous motor vehicle 12. For this purpose, in particular a vehicle-to-infrastructure communication can be provided, e.g., using a 5G technology.

The predefined roadway marking 20 may stand out optically from the road 14, in particular from other roadway markings such as the centerline. For example, the predefined roadway marking 20 can in one embodiment be a tram rail, which extends on the road 14. In this exemplary embodiment, the predefined roadway marking 20 is a solid line in the center of one side of the road and may use marking paint which makes the predefined roadway marking 20 stand out from the road 14. In particular, the marking paint can be a fluorescent paint.

The predefined roadway marking 20 may emit an electromagnetic signal, for example, in that a current-conducting wire or multiple induction coils arranged in succession extend along the predefined roadway marking 20. In the case of the induction coils, in addition to a possibility of determining a position of the autonomous motor vehicle on the predefined roadway marking 20 by way of the sensor unit 16, in that the electromagnetic signal is detected, there is the possibility that an induction coil in the road can couple with an induction coil 24 of the autonomous motor vehicle and can thus charge a traction battery (not shown) of the autonomous motor vehicle during a journey.

If it is determined by the sensor unit 16 that the autonomous motor vehicle 12 is not located on the predefined roadway marking 20, the control unit 18 can limit a vehicle speed to a predefined safety value. The predefined safety value can limit the vehicle speed to a value at which in a hazardous situation the autonomous motor vehicle 12 can quickly be brought to a standstill. In particular, the predefined safety value can be a walking speed which can be in a range of 1 to 16 km/h. Therefore, in critical driving situations, the autonomous motor vehicle 12 can be put into a safe state exclusively by braking, due to which accidents can be avoided.

If it is established by the sensor unit 16 that the autonomous motor vehicle 12 is located on the predefined roadway marking 20, the autonomous motor vehicle 12 can be controlled by the control unit 18 on the predefined roadway marking, that is to say, it can be maneuvered along the predefined roadway marking 20. For this purpose, the control unit 18 can limit the vehicle speed to a predefined speed value, which can be defined, for example, by the urban area or the presently traveled road 14 and can represent a permissible highest speed. This permissible highest speed can be established by the sensor unit 16, for example, by detecting a road sign or can be communicated to the autonomous motor vehicle 12 from an external source, for example, the external sensor 22. For example, the vehicle-external sensor 22 can also transmit data to the motor vehicle in addition to an item of position information, in particular the predefined, permitted speed.

It is thus possible that the autonomous motor vehicle 12 can drive on the predefined roadway marking 20 at a maximum permitted speed, since other road users can predict a path of the autonomous motor vehicle, similarly to the path of a tram on tram rails. The behavior of the autonomous motor vehicle is thus always comprehensible to further road users.

To further increase the level of traffic safety, a safety area 26 can be provided during the journey in front of the autonomous motor vehicle 12, which covers, for example, a side of the road in front of the autonomous motor vehicle 12 and can be dynamically adapted to the speed of the autonomous motor vehicle 12. If it is ascertained by the sensor unit 16 of the autonomous motor vehicle or by the vehicle-external sensor 22 that an object, for example another vehicle, is located inside the safety area in front of the autonomous motor vehicle, the control unit 18 can adapt the vehicle speed to an object speed, for example to a speed of the vehicle driving ahead, in that it reduces the speed in particular in the case of a slowly driving vehicle.

In addition to the safety area 26, an observation area 28 can be provided, which expands the safety area 26. Objects, for example a pedestrian 30, can be monitored in the observation area 28 as to whether they move into the safety area 26. A speed of the pedestrian 30 in the direction of the safety area 26 can be established, for example, in that a position changing over time of the pedestrian is extrapolated. If it is established that this speed and position of the pedestrian correspond to a predefined condition, the control unit 18 can cause the autonomous motor vehicle 12 to reduce the vehicle speed and in case of a sudden entry of the pedestrian into the safety area 26, can cause emergency braking.

The predefined condition can occur, for example, if the pedestrian 30 exceeds a predefined speed in the direction of the safety area 26. In particular, however, it can be provided that upon the reduction of the vehicle speed, the autonomous motor vehicle 12 remains on the predefined roadway marking 20. This means that even in the event of emergency braking, no evasion maneuver is to be carried out, due to which other road users could be endangered. The behavior of the autonomous motor vehicle on the predefined roadway marking 20 is thus predictable for every road user due to the provision of the roadway marking which is comprehensible and visible to other road users. The boundary conditions for creating legal requirements in the case of accidents of autonomous motor vehicles can thus also be created.

FIG. 2 shows a schematic illustration of a passing process of the autonomous motor vehicle according to an exemplary embodiment. In this embodiment, an object 32, which can be a parking vehicle, for example, can block the predefined roadway marking 20 on the road 14. The autonomous motor vehicle 12 can approach this object 32 and upon entry of the object 32 into the safety area of the autonomous motor vehicle, the autonomous motor vehicle 12 can reduce its speed and come to a standstill behind the object 32, for example. In order that the autonomous motor vehicle 12 can nonetheless continue the journey, it can be provided that the autonomous motor vehicle 12 leaves the predefined roadway marking 20 to pass the object 32. For this purpose, it can be checked whether a speed of the autonomous motor vehicle is below the predefined safety value, for example, the walking speed. If this is the case, the autonomous motor vehicle 12 can leave the predefined roadway marking 20 and drive past the object 32.

So as not to obstruct or endanger oncoming vehicles, in addition the vehicle-external sensor 22, which can be located on the side of the road, can send an item of information about oncoming traffic to the autonomous motor vehicle 12. Alternatively or additionally, oncoming vehicles (not shown) can send position data via a vehicle-to-vehicle communication to the autonomous motor vehicle 12.

When leaving the predefined roadway marking 20 to pass the object 32, the autonomous motor vehicle can briefly drive on the opposite roadway, where a roadway marking (not shown) can also be provided, for example. In order that the autonomously driving motor vehicle 12 does not detect this as its own and thus releases the speed to the permitted speed value, it can be provided that a radio frequency identification chip (RFID) is provided within the predefined roadway marking 20, which identifies a lane for the autonomous motor vehicle, whereby confusing the lane can be avoided.

Alternatively to passing the object 32, for example, leaving the predefined roadway marking 20 can also be carried out to drive to a parking area beyond the predefined roadway marking.

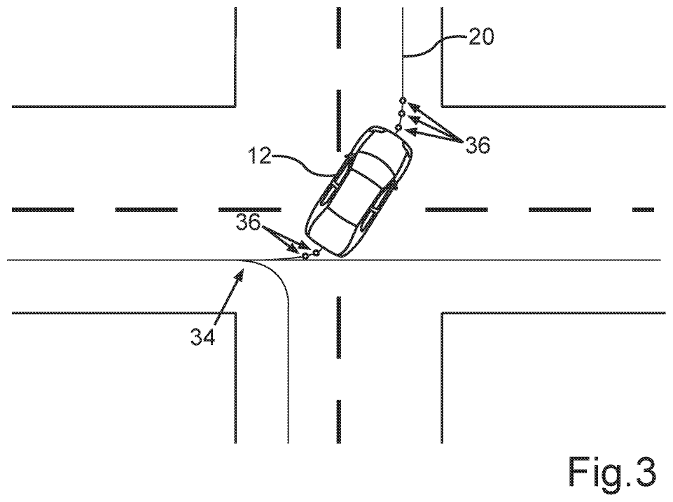

FIG. 3 shows a road intersection and a turnoff process of the autonomous motor vehicle 12 according to an exemplary embodiment of the track guidance system 10. For example, the predefined roadway marking 20 can extend in different directions at a road intersection. In particular, the predefined roadway marking 20 can divide at an intersection point 34. The intersection point 34 can be embodied in such a way that a continuous, differentiable, and unambiguous movement sequence of the autonomous motor vehicle 12 results. For this purpose, in addition an optical signal can be provided on and/or in the roadway marking, which indicates a travel route of the autonomous motor vehicle. In particular, the optical signal can be induced by a light band 36, which can indicate the course of the travel route of the autonomous motor vehicle at the intersection point 34. Therefore, in addition to a signal indication of the autonomous motor vehicle, the predefined roadway marking 20 can also indicate the travel route of the motor vehicle and thus increase a level of traffic safety, since other road users can be made aware of the path of the motor vehicle.

Guiding of the motor vehicle along the roadway marking 20 is also provided during the turnoff process of the autonomous motor vehicle 12. For this purpose, the vehicle center point or center of gravity of the vehicle can be guided as precisely as possible on the roadway marking 20. For example, permissible tolerances can be defined in the transverse direction in legal boundary conditions. In particular, a deviation of the vehicle center point from the roadway marking 20 can be at most 50 cm.

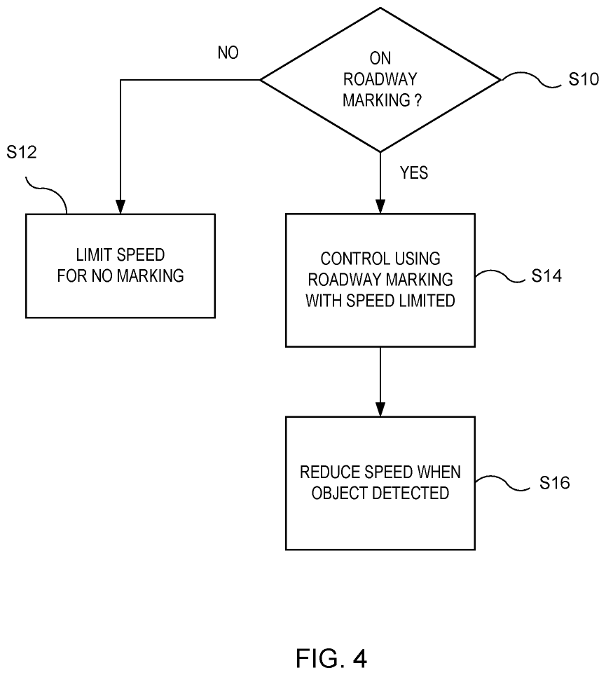

FIG. 4 shows a schematic method diagram according to an exemplary embodiment.

In S10 it is determined whether the autonomous motor vehicle 12 is located on a predefined roadway marking 20. If this is answered in the negative, in S12, a vehicle speed is limited to a predefined safety value.

If it is determined that the autonomous motor vehicle 12 is located on the predefined roadway marking 20, in S14, the autonomous motor vehicle 12 can be controlled on the predefined roadway marking 20, wherein the vehicle speed is limited to a predefined speed value.

If the vehicle is controlled on the predefined roadway marking 20, it can be ascertained in S16 whether an object is located within a safety area in front of the autonomous motor vehicle and/or whether a movement of the object from an observation area in the direction of the safety area corresponds to a predefined condition and if this is the case, the vehicle speed can be reduced, wherein the autonomous motor vehicle 12 remains on the predefined roadway marking 20 during the reduction of the vehicle speed if the vehicle speed is above the predefined safety value.

Overall, the examples show how a lane marking for autonomous motor vehicles can be provided for use by the method described herein.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-10. (canceled)

11. A method for controlling an autonomous motor vehicle in an urban area, comprising:
determining whether the autonomous motor vehicle is located on a predefined roadway marking;
limiting a vehicle speed to a predefined safety value within a range of 5 km/h to 15 km/h, when the autonomous motor vehicle is not located on the predefined roadway marking; and
otherwise controlling the autonomous motor vehicle on the predefined roadway marking and limiting the vehicle speed to a predefined speed value.

12. The method as claimed in claim 11, wherein the controlling further comprises:
ascertaining whether an object is located within a safety area in front of the autonomous motor vehicle and extending along the predefined roadway marking; and
reducing the vehicle speed to an object speed, when the object is located within the safety area, the autonomous motor vehicle remaining on the predefined roadway marking during the reduction of the vehicle speed while the vehicle speed is above the predefined safety value.

13. The method as claimed in claim 12, wherein the controlling comprises:
ascertaining whether a movement of the object from an observation area toward the safety area corresponds to a predefined condition; and
reducing the vehicle speed while maintaining the autonomous motor vehicle on the predefined roadway marking, when the predefined condition is met.

14. The method as claimed in claim 13, wherein the ascertaining of whether the object is one of located in the safety area and moving toward the safety area is performed by one of a vehicle-internal sensor and a vehicle-external sensor.

15. The method as claimed in claim 14, wherein the controlling includes the autonomous motor vehicle leaving the predefined roadway marking only after the vehicle speed meets the predefined safety value.

16. The method as claimed in claim 15, wherein the predefined roadway marking divides at an intersection point, and a travel route of the autonomous motor vehicle is indicated by an optical signal at least one of on and in the predefined roadway marking.

17. The method as claimed in claim 16, wherein the predefined roadway marking is indicated by at least one of a tram rail and marking paint.

18. The method as claimed in claim 17, wherein the predefined roadway marking is furthermore indicated by an electromagnetic signal.

19. The method as claimed in claim 12, wherein the ascertaining of whether the object is located in the safety area is performed by one of a vehicle-internal sensor and a vehicle-external sensor.

20. The method as claimed in claim 11, wherein the controlling includes the autonomous motor vehicle leaving the predefined roadway marking only after the vehicle speed meets the predefined safety value.

21. The method as claimed in claim 11, wherein the predefined roadway marking divides at an intersection point, and a travel route of the autonomous motor vehicle is indicated by an optical signal at least one of on and in the predefined roadway marking.

22. The method as claimed in claim 11, wherein the predefined roadway marking is indicated by at least one of a tram rail and marking paint.

23. The method as claimed in claim 11, wherein the predefined roadway marking is indicated by an electromagnetic signal.

24. A track guidance system for controlling an autonomous motor vehicle in an urban area, comprising:
a sensor configured to determine whether the autonomous motor vehicle is located on a predefined roadway marking; and
a control unit configured to
limit a vehicle speed to a predefined safety value within a range of 5 km/h to 15 km/h, when the autonomous motor vehicle is not located on the predefined roadway marking, and
control the autonomous motor vehicle and limit the vehicle speed to a predefined speed value when the autonomous motor vehicle is located on the predefined roadway marking.

25. The track guidance system as claimed in claim 24, wherein the control unit is further configured to ascertain whether an object is located within a safety area in front of the autonomous motor vehicle and extending along the predefined roadway marking; and
reduce the vehicle speed to an object speed, when the object is located within the safety area, the autonomous motor vehicle remaining on the predefined roadway marking during the reduction of the vehicle speed while the vehicle speed is above the predefined safety value.

26. The track guidance system as claimed in claim 25, wherein the control unit is further configured to
ascertain whether a movement of the object from an observation area toward the safety area corresponds to a predefined condition; and
reduce the vehicle speed while maintaining the autonomous motor vehicle on the predefined roadway marking, when the predefined condition is met.

27. The track guidance system as claimed in claim 26, wherein the control unit is further configured to move the autonomous motor vehicle away from the predefined roadway marking only after the vehicle speed meets the predefined safety value.

28. The track guidance system as claimed in claim 27, wherein the predefined roadway marking divides at an intersection point, and wherein a travel route of the autonomous motor vehicle is indicated by an optical signal at least one of on and in the predefined roadway marking.

29. The track guidance system as claimed in claim 28, wherein the predefined roadway marking is indicated by at least one of a tram rail and marking paint.

30. The track guidance system as claimed in claim 29, wherein the predefined roadway marking is furthermore indicated by an electromagnetic signal.
